(19) United States
(12) Patent Application Publication
(10) Pub. No.: US 2002/0094579 A1
(43) Pub. Date: Jul. 18, 2002

(54) Methods of determining concentration of a component of a slurry

(75) Inventors: Ashutosh Misra, Plano, TX (US); Matthew L. Fisher, Dallas, TX (US)

Correspondence Address: Jeffrey L. Wendt, Esq., Winstead Sechrest & Minick, 5400 Renaissance Tower, 1201 Elm Street, Dallas, TX, 75270, US

(73) Assignee: Air Liquide America Corporation, Houston, TX (US)

(21) Appl. No.: 10/029,083

(22) Filed: Dec. 20, 2001

Related U.S. Application Data
(60) Provisional application No. 60/257,700, filed on Dec. 21, 2000.

(51) Int. Cl. G01N 21/00

(52) U.S. Cl. 436/55; 436/164

(57) ABSTRACT

A method of determining a concentration of a component of a slurry includes the step of measuring change in refractive index associated with changes in concentration of the component of interest in the slurry.

### CROSS-REFERENCE TO RELATED APPLICATION

This application is related to the provisional application for patent entitled “METHOD OF DETERMINING CONCENTRATION OF A COMPONENT OF A SLURRY” filed Dec. 21, 2000 by the inventors Misra and Fisher (Attorney Docket No. SERIE 5565 [25185-P006V1]) and granted U.S. Serial No. 60/257,700, currently pending.

### BACKGROUND OF THE INVENTION

1. Field of the Invention

The present invention relates in general to chemical analysis techniques and in particular, to methods of determining composition of a component of a slurry.

2. Background of Invention

In order to provide more functionality per chip, semiconductor manufacturers continue to search for ways to decrease feature size while still maintaining high process yields. As feature size decreases, tighter rules are required over the various process steps, including the photolithography steps used to pattern the various structures, such as transistors, vias, dielectric regions, and various levels of interconnect.

Consider, for example, chemical-mechanical planarization or CMP. CMP is used to planarize surfaces of the semiconductor wafer being processed such that the photolithographic projection can be accurately focused. The particularly slurry chemistry used is dependant on the composition of the layer being polished (e.g. oxide. tungsten, copper), but generally includes particles suspended in a carrier solution along with other reagents which render the surface of the wafer susceptible to abrasion by the suspended particles. A slurry flow is introduced between the wafer and a polishing pad. The wafer and the polishing pad then rotate with respect to each other to effectuate the mechanical component of the CMP operation. Specifically, as the wafer rotates, the suspended particles abrade the surface of the wafer and the removed material is flushed away in the slurry flow.

Precise CMP is a non-trivial task involving numerous processing variables with respect to both the slurry chemistry and the mechanical polishing operation. With particular respects to the slurry composition, the amounts of the various reagents used must be carefully controlled, sometimes within a few percent, in order to achieve the desired result. For example, an oxidizer is typically used to aid in the removal of material from the wafer surface. If the amount of oxidizer in the slurry is too low, then material removal will be too small and if the oxidizer concentration is too high, undesired chemical reactions can result. This problem is compounded by the fact that some reagents, such as oxidizers, deteriorate and therefore may require careful reintroduction into the system.

Hence, some accurate means is required for monitoring reagent levels in the slurry. Monitoring the slurry composition however presents its own set of problems. Not only must the monitoring method be accurate, but it must allow periodic monitoring of the slurry being used without being unduly intrusive on the overall manufacturing operation.

### SUMMARY OF INVENTION

According to the inventive concepts, methods are disclosed for determining the concentration of a component of a slurry, including the steps of measuring a change in refractive index associated with changes in concentration of the component of interest.

The inventive concepts allow for the accurate monitoring of small changes in a component of interest in a manufacturing process composition in a non-instrusive and time-effective manner. One particular application of these concepts is in the measurement of reagent concentration changes in the CMP slurries used during semiconductor fabrication. For example, oxidizer concentration in a CMP slurry may vary by small, but nonetheless significant, amounts due to deterioration. The disclosed methods allow these changes to be detected such that remedial measures can be taken. Moreover, different techniques for measuring changes in refractive index are available to implement these methods, including refractometry and surface plasmon resonance detection.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is illustrates a slurry distribution system suitable for demonstrating the principles of the present invention;

FIG. 2 is graph of the Temperature Corrected Refractive Index versus Concentration by percent weight of a mixture of a commercially available slurry and water /hydrogen peroxide, as measured with a bench-top refractometer;

FIG. 3 is a diagram showing changes in hydrogen peroxide concentration in the commercially available slurry with time and its detection by a surface plasmon resonance detector according to the inventive principles.

### DETAILED DESCRIPTION OF THE INVENTION

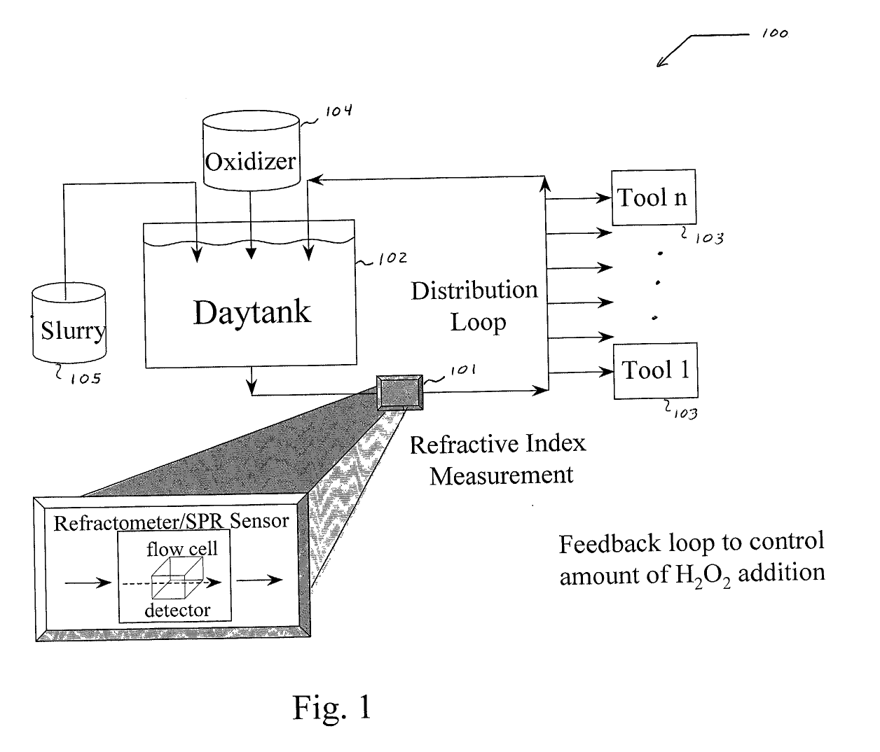

The principles of the present invention and their advantages are best understood by referring to the illustrated embodiment depicted in FIGS. 1-3 of the drawings, in which like numbers designate like parts.

There are several possible techniques for determining the concentration of a reagent in a slurry. For example, the conductivity of the solution could be monitored for changes as the reagent level varies, although this technique will normally not work with respect to non-ionic reagents such as H₂O₂, unless the concentration is very high. Another possibility is to take a sample of slurry and then perform a titration, such as with potassium permanganate in the case of H₂O₂ measurements. However, titration is not instantaneous, typically requiring multiple runs, calibration, and standard checks to insure accuracy. Finally, a pH test could be performed, but a pH test is also not a viable option for reagents such as oxidizers, small variations of which may not cause a measurable change in slurry pH.

According to the inventive principles, small changes in the refractive index are measured to monitor the oxidizer concentration of a slurry. The slurry can be any of a number of slurries used during the semiconductor fabrication process, including those used for oxide, tungsten and copper CMP slurries, among others. It should also be recognized that the inventive method is not limited to oxidizers, but to other reagents forming the slurry composition.

FIG. 1 is a schematic diagram of a slurry distribution system 100 embodying the principles of the present invention and useful for such applications as the fabrication of semiconductor devices. System 100 includes a refractive index measurement device 101 for monitoring the oxidizer concentration of a slurry being passed through a distribution loop including a daytank 102 and one or more CMP tools 103. Preferrably, measurement device 101 is a commercially available refractometer Leica AR600 Automatic Refractometer with a resolution of 0.00001 refractive index units. The typical refractometer includes a charge coupled device (CCD) sensor array which measures the refraction of a beam of light direct through a chemical composition.

The concentration of oxidizer is relayed back by a feedback loop to chemical dispensers 104 and 105 such that the amount of oxidizer and/or fresh slurry can be adjusted to compensate for an undesirable level of oxidizer being delivered to CMP tools 103.

In alternate embodiments, a surface plasmon resonance detector is used to continuously monitor changes in refractive index. Surface plasmon resonance detectors are commercially available, such as the Spectral® Sensor from Texas Instruments.

One particular instance where the present invention is particularly useful is in the monitoring of hydrogen peroxide (H₂O₂), which is typically used as an oxidizing agent in CMP slurries. For example, a common commercially available slurry used for polishing tungsten might include a silica (SiO₂) abrasive in a carrier of HNO₃ and Fe(NO₃)₃, along with various organic acids, corrosion inhibitors and film forming agents. The end-user then adds H₂O₂ on-site, both initially and periodically thereafter, since H₂O₂ decomposes with time. The exact concentration will vary from application to application. For some applications, the percentage of H₂O₂ in the slurry might be maintained in a relatively narrow range, for example, 1.5 to 2.0%. Exemplary processes for preparing and purifying hydrogen peroxide are described in co-assigned United States Patents Nos.: U.S. Pat. No. 5,932,187, for Process For The Preparation Of An Ultra Pure Hydrogen Peroxide Solution By Ionic Exchange In Beds Having Defined H/D Ratios; U.S. Pat. No. 5,928,621, for Process For The Preparation Of An Ultra Pure Solution Of Hydrogen Peroxide By Ion Exchange With Recycling; U.S. Pat. No. 5,961,947, for Process For The Preparation Of An Ultra Pure Solution Of Hydrogen Peroxide By The Ion Exchange Sequence: Anionic—Cationic—Anionic—Cationic; U.S. Pat. No. 6,001,324, for Process For The Preparation Of An Ultra Pure Hydrogen Peroxide Solution By Ion Exchange In The Presence of Acetate Ions; U.S. Pat. No. 6,183,638, for Plant For The Preparation Of An Ultra Pure Hydrogen Peroxide Solution By Ionic Exchange In Beds Having Defined H/D Ratios; and U.S. Pat. No. 6,187,189, for Process For The Preparation Of An Ultrapure Solution Of Hydrogen Peroxide By Ion Exchange with Recycling, all to Ledon et al. and incorporated herein by reference.

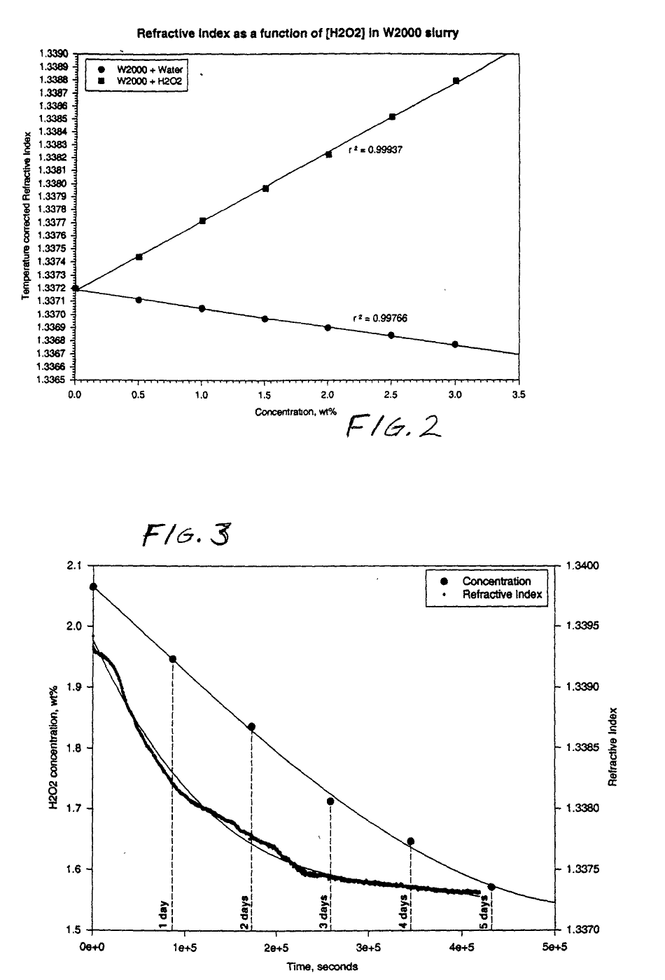

The principles of the present invention were demonstrated using W-2000-tungsten CMP slurry commercially available from Cabot Microelectronics. FIG. 2 is graph of the Temperature Corrected Refractive Index versus Concentration by percent weight of W-2000 slurry of water and hydrogen peroxide, as measured with the bench-top refractometer. The data-fitted upper curve shows the slurry refractive index increasing with increasing hydrogen peroxide concentration. The data-fitted lower curve shows the refractive index decreasing with increasing water concentration.

FIG. 3 illustrates the results of a second demonstration, in this case using a surface plasmon resonance detector. Here, the hydrogen peroxide concentration and corresponding refractive index are plotted against time. As shown, without replenishment, the H₂O₂ concentration decreases with time due to deterioration. The decreasing H₂O₂ concentration manifests itself with a correspondingly decreasing refractive index.

Measuring the refractive index of the slurry to monitor the concentration of a selective reagent has substantial advantages. For example, this method is more accurate than making conductivity or pH measurements, especially when small variations in reagent concentration and/or non-ionic reagents are involved. Additionally, refractive index measurements can be made quickly and with minimum intrusion into the process being monitored, in contrast to titration and similar techniques.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A method of determining a concentration of a component of a slurry, the method comprising the step of measuring change in refractive index associated with changes in concentration of the component of interest in a slurry.

2. The method in accordance with claim 1 wherein the slurry is selected from the group consisting of slurries for tungsten CMP and slurries for copper CMP.

3. The method in accordance with claim 1 wherein the change of refractive index is less than 0.001 units.

4. The method in accordance with claim 1 wherein the change of refractive index is less than 0.0001 units.

5. The method in accordance with claim 1 employing a refractometer having resolution n of 0.00001 units.

6. The method in accordance with claim 5 wherein the refractometer is a bench-top unit.

7. The method in accordance with claim 1 wherein the component of interest is an oxidizing agent.

8. The method in accordance with claim 7 wherein the oxidizing agent is non-ionic.

9. The method in accordance with claim 7 wherein the oxidizing agent is hydrogen peroxide.

10. A method of controlling an oxidizer concentration in a slurry by employing the methods of claim 1 and using data obtained to adjust the oxidizer concentration accordingly.

11. A method of controlled abrasion of a surface employing a slurry, the slurry comprising an oxidizer, the method comprising using the steps of claims 1.

12. The method in accordance with claim 1, 10, or 11 wherein a solid state sensor operating on the principle of surface plasmon resonance was used for real-time monitoring of changes in refractive index.

13. A method of monitoring changes in a concentration of a reagent in a manufacturing process composition comprising the step of measuring changes in a refractive index of the composition.

14. The method in accordance with claim 13 wherein the step of measuring comprises the step of measuring changes with a refractometer.

15. The method in accordance with claim 13 wherein the step of measuring comprises the step of measuring changes with a surface plasmon resonance detector.

16. The method in accordance with claim 13 wherein the semiconductor processing composition comprises a CMP slurry.

17. The method in accordance with claim 13 wherein the reagent comprises an oxidizer.

18. The method in accordance with claim 17 wherein the oxidizer comprises hydrogen peroxide.

19. The method in accordance with claim 13 wherein the changes monitored are a decrease in the concentration of the reagent from deterioration.

20. The method in accordance with claim 16 wherein the CMP slurry is selected from the group consisting of tungsten and copper CMP slurries.
